(19) United States
(12) Patent Application Publication
(10) Pub. No.: US 2013/0035079 A1
(43) Pub. Date: Feb. 7, 2013

(54) METHOD AND SYSTEM FOR ESTABLISHING DATA COMMUICATION CHANNELS

(71) Applicant: Anthony Michael O'Doherty, Sligo (IE)

(72) Inventor: Anthony Michael O'Doherty, Sligo (IE)

(21) Appl. No.: 13/577,414

(22) PCT Filed: Feb. 3, 2011
(86) PCT No.: PCT/IB11/00174

§ 371 Date: Oct. 22, 2012

(30) Foreign Application Priority Data
Feb. 5, 2010 (IE) S20100060

(51) Int. Cl. H04M 11/00; H04W 4/00

(52) U.S. Cl. 455/414.1; 379/93.09

(57) ABSTRACT

A method and system for establishing data communications channels between users is disclosed. These data communications channels may be used for file transferring, internet collaborations, etc. In one embodiment, a data communications channel is automatically established between two user devices upon the establishment of a voice communications channel between communications devices associated with said user devices. In this embodiment, the data communications channel is set up without any additional input from the user. In another embodiment, a data communications channel is used to transfer files between user communication devices. The method and systems of the invention may use unique identifiers to establish the data communications channels. In the event that the communications devices are telephones, a user's telephone number may comprise at least part of the unique identifier. In one embodiment, only the telephone number of another user is needed to establish the data communications channel.

This invention relates to a method for establishing a data communications channel between communications devices on a network.

Over the past decade or so, communications have evolved beyond simple voice communications and faster data transfer speeds have allowed visual-based communications to come to the fore. In particular, video calling, online real-time collaboration over shared workspaces, remote device access sessions and general multimedia sharing have become common place in communications between parties who would have otherwise been limited to simple voice communications between each other.

The advent of online collaborations over shared workspaces, access to remote devices such as home computers or work computers, and, sharing of multimedia files has been particularly beneficial to users who are separated from one another geographically. Visual-based communications have allowed efficient and immersive communications to take place between these users, and consequently information can be shared quickly between the users by using visual-based methods. This has been found to be a far more efficient and error-free way to exchange information between users in comparison to voice only communications.

Visual-based communications are implemented by what is essentially a data communications channel, and this data communications channel is often set up as separate entity from the establishment of the voice communications channel. This is particularly true for online collaboration, remote device access sessions and general multimedia sharing; and, up to now, it has been typical for the data communications channel to be set up manually by users separately from the set up of a voice communications channel between the same users.

In addition to visual-based communications, data channels may also be used to exchange audio-based communications between user devices. For example, an audio file may be streamed from one user's device to another user's device over the data channel, or, packets of audio data may be exchanged between user devices over a duplex data channel. The data channel may alternatively be used to allow data to be transferred between user devices so that background applications and services can be provided. For example, one of the user devices may assume a master role and the other user device may assume a slave role. The master user device may then retrieve diagnostic information from the slave user device without requiring any input from the user. Such a process would be carried out in the background without the user's knowledge. It will be readily understood that many different background processes can be carried out using a data channel established between user devices.

However, it has been found that a reasonable level of knowledge and experience is required in order to set up the data communications channel. Many potential users do not possess this level of knowledge and/or experience, and therefore find it very cumbersome and difficult to set up the data communications channel due to the complexity involved with setting up web cameras and/or software.

Most data communications channels need to be set up by the users themselves by inputting various addresses, port numbers, usernames and passwords along with configuring several settings on their devices in order to allow data communications to take place between their device and another user's device on a network. This setup process can be a rather daunting task and it is confusing to many people who do not have a large amount of experience and expertise in working with computers and other such devices. As a result, potential users who would benefit from a data communications channel in addition to a voice communications channel are deterred from establishing a data communications channel as the effort to do so is seen to be too great in comparison to the potential reward. Even those users that do attempt to set up data communications channels typically find the process very difficult, and more often than not, it has been found that the associated loss in productivity due to the amount of time which is expended by the user in setting up the data channel does not warrant carrying out the task.

Some systems that attempt to partially automate the process have been developed. In essence these systems operate by allowing a user to schedule a meeting with a service provider and specify to that service provider that a shared workspace or other such data communications channel is required for the duration of the meeting between all or some of the invitees to that meeting in order to set up the data communications channel. The invitees are then sent an e-mail or some such message by the service provider informing them of the meeting with a web link to click on at the appropriate time for the meeting. In some systems, a call back to the invitee is carried out by the service provider in order to establish the voice communications channel.

If a user is only intending on communicating for a short period of time, even for experienced users, the effort involved in establishing the data communications channels in addition to the voice communications channel may be seen to be too great. This may be the case even though there would be a benefit to having a data communications channel. The users may not believe it to be worthwhile to set up the data communications channel and may instead attempt to communicate using a voice communications channel only.

Furthermore, these partially automated systems have also been found to be somewhat complex and the user must stipulate on each occasion, in advance, if they wish for a data communications channel to be established in addition to a voice communications channel. The service can not be viewed as being a pre-configurable automatically connectable service as a degree of planning and preparation is involved. As such, these partially automatic systems which involve a call back service to establish the voice communications link along with the data communications link are considered to be particularly cumbersome to use.

Clearly this is not ideal as the user does not feel in complete control of the system, and inter alia, is reliant on the service provider to call back in a timely manner at the scheduled time. As is the case with all systems, these systems are prone to error and users have found these systems frustrating to deal with; especially when an error occurs, there is little the user can immediately do themselves to attempt to solve the problem. The service provider must be contacted and it is then the service provider that will attempt to rectify the problem. This takes additional time which adds to the user's frustration with using such services.

It is a goal of the present invention to provide an apparatus/method that overcomes at least one of the above mentioned problems.

### SUMMARY OF THE INVENTION

The present invention is directed to a method of establishing a data communications channel between two or more user devices over a communications network, the data communications channel being associated with, but independent from, a voice communications channel established between two or more user communication devices over a telephony network; wherein, the method establishes the data communications channel using identification keys that are used to establish the voice communications channel.

The advantage of providing an automatically generated data communications channel on the basis of identification keys that are used in establishing the voice communications channel is that the user input is minimised. The user does not need to define any addresses, ports or other such configurations details for the data communication is channel to be established. The establishment of a normal telephone call is thus used to initiate the automatic establishment of an associated, but separate data communication channel.

Given that the majority of people are extremely familiar with using mobile communication devices and fixed line communication devices to establish telephone calls over voice communication channels, this method presents a particularly simple and effective way to create a data communications channel without any significant input from the user.

Moreover, the system can pre-configure a user's settings and map these settings to their identification key, such that their identification key, and the identification key of a destination communication device, dictate which type of data communications channel is set up and how the data communications channel is set up.

An appropriate data communications channel may be set up depending on different scenarios and user settings. For example, an appropriate data communications channel may be an on-line collaboration over a shared workspace if the destination communication device is a work colleague, or, the appropriate data communications channel may be a web link to a social networking site if the destination communication device is a friend.

In a further embodiment, the method uses a signalling protocol to establish the data communications channel between the two or more user devices.

In a further embodiment, the identification keys are used to form at least part of an address for the signalling protocol.

In a further embodiment, the signalling protocol is the Session Initiation Protocol, commonly abbreviated as SIP.

In a further embodiment, the signalling protocol is the Intelligent Network Application Part, commonly abbreviated as INAP.

In a further embodiment, the identification keys are mapped to a user device's address on the communications network using a mapping database stored in a communications management hub on the communications network.

In a further embodiment, the identification keys are selectively mapped to the user device's addresses dependant on user defined settings stored in the communications management hub.

The advantage of using these user-defined settings which are stored in the communications management hub is that the user of the communications device can define which type of data communications channel they wish to be established dependent on the destination communication device and at what time the call is being placed.

In a further embodiment, the user defined settings comprise one or more of: day of the week, time of day, identification of user establishing the voice communications channel, privacy settings, location of user devices and/or location of user communication devices.

In a further embodiment, the communication devices are mobile telephones and the user devices are networked computers.

In a further embodiment, at one of the user communication devices is a conferencing bridge and one of the user devices is a computer server.

In a further embodiment, the user device and the user communication device are a mobile telephone.

In a further embodiment, the telephony network and the communications network are at least partially provided by the same network.

### DETAILED DESCRIPTION OF EMBODIMENTS

The invention will be more clearly understood from the following description of some embodiments thereof, given by way of example only with reference to the accompanying drawings, in which:

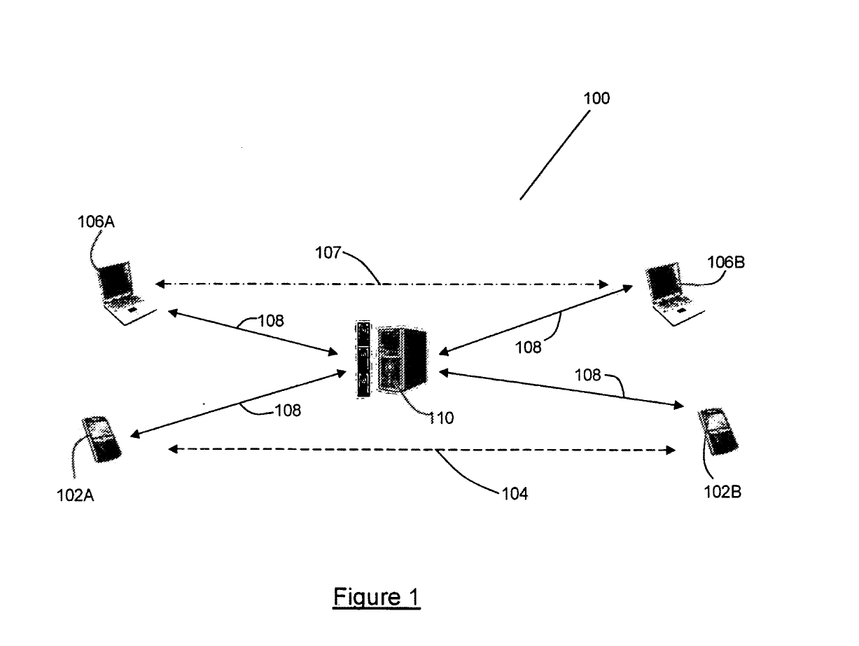

FIG. 1 is a diagrammatic view of a voice communication channel and a plurality of data communication channels in accordance with the present invention;

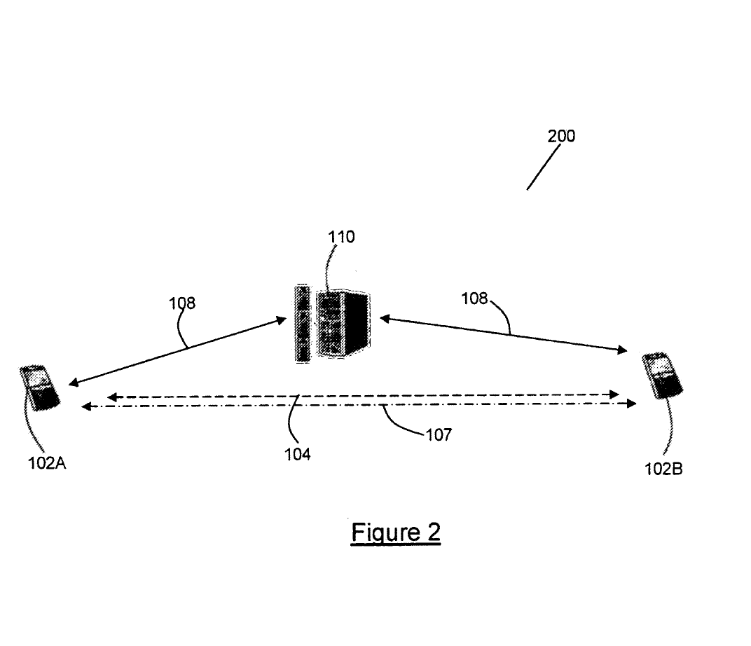

FIG. 2 is a diagrammatic view of a voice communication channel and a plurality of data communication channels in accordance with a further embodiment of the present invention;

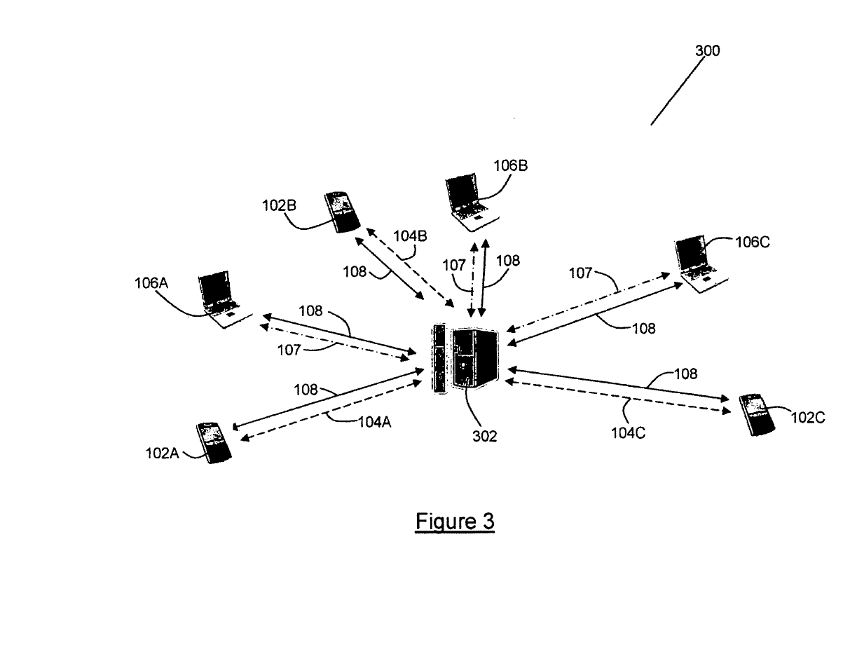

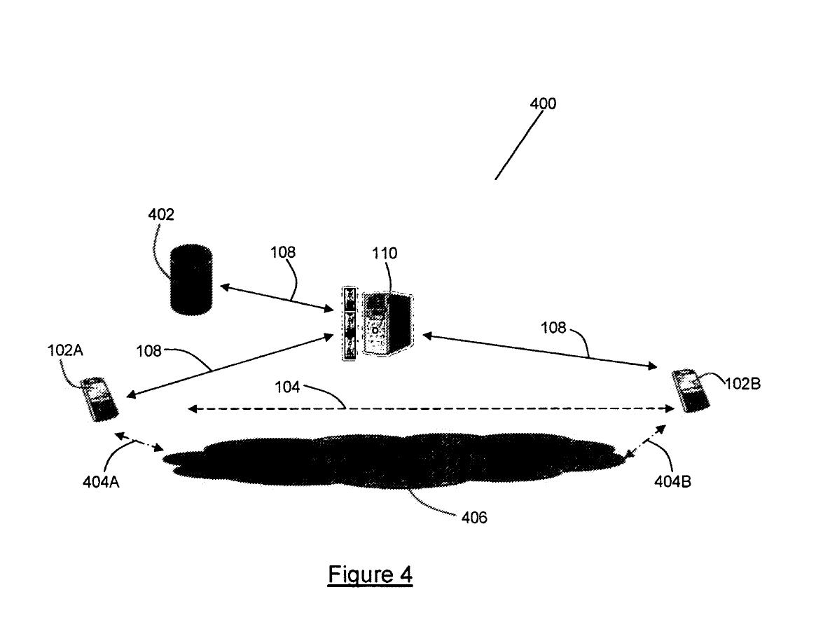

FIG. 3 is a diagrammatic view of a plurality of voice communication channels and a plurality of data communication channels in accordance with a further embodiment of the present invention;

FIG. 4 is a diagrammatic view of a plurality of voice communication channels and a plurality of data communication channels in accordance with a further embodiment of the present invention;

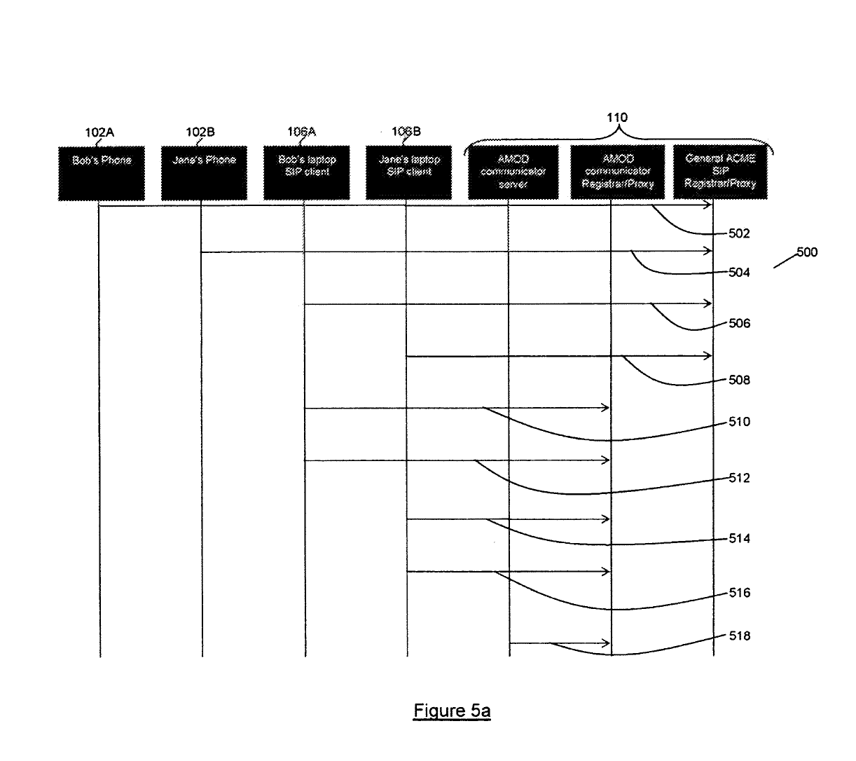

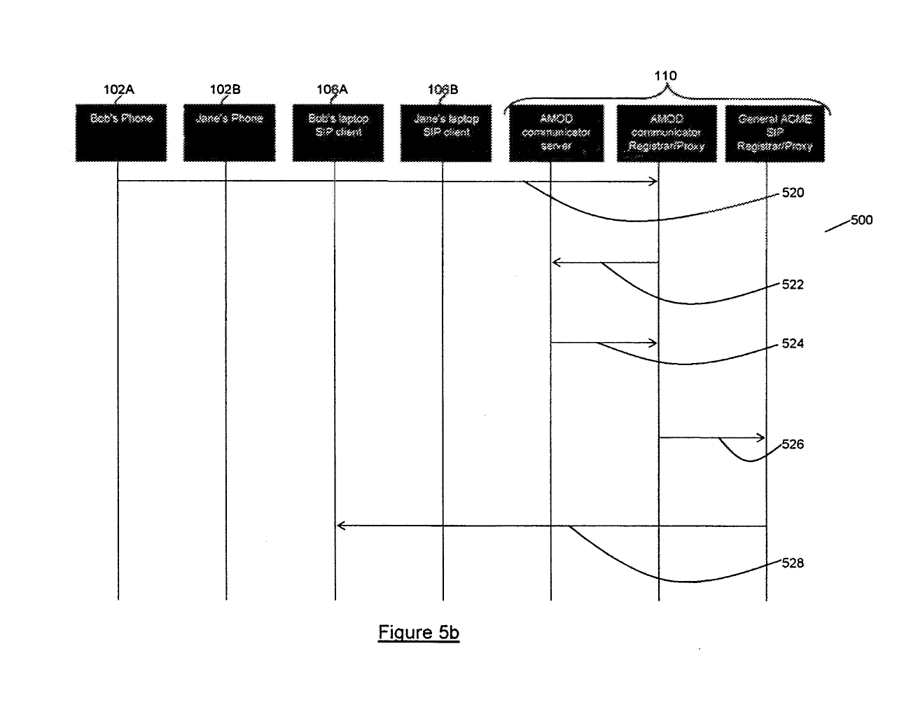

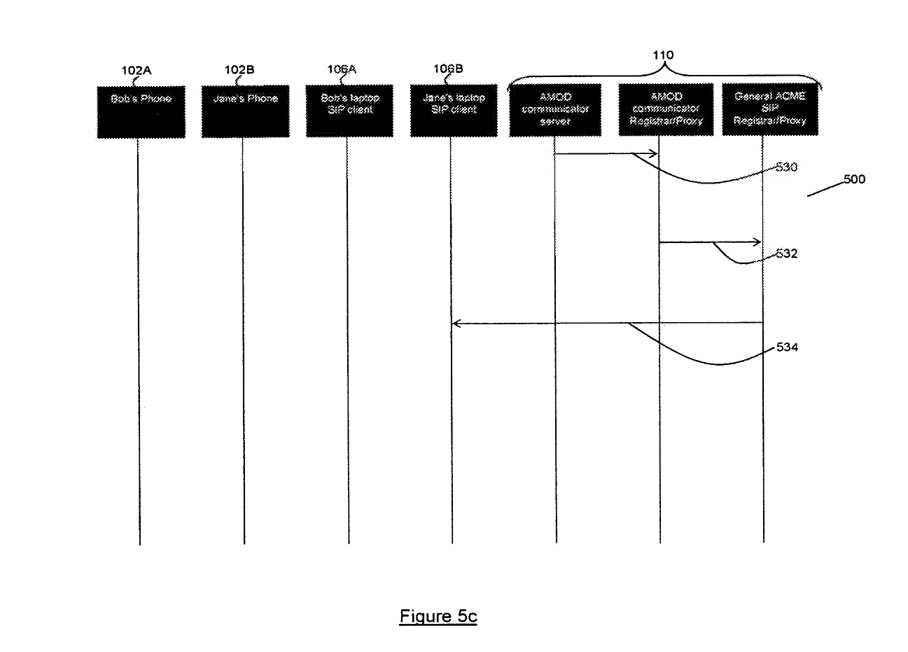

FIGS. 5a to 5c are messaging sequencing charts showing the establishment of a data communications channel in accordance with an embodiment of the present invention; and,

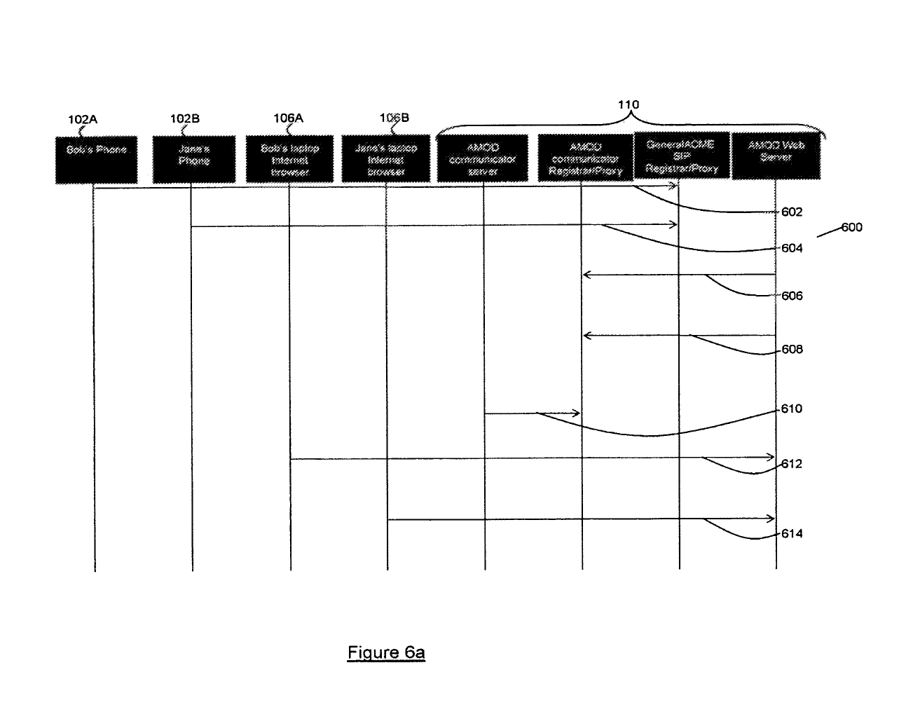

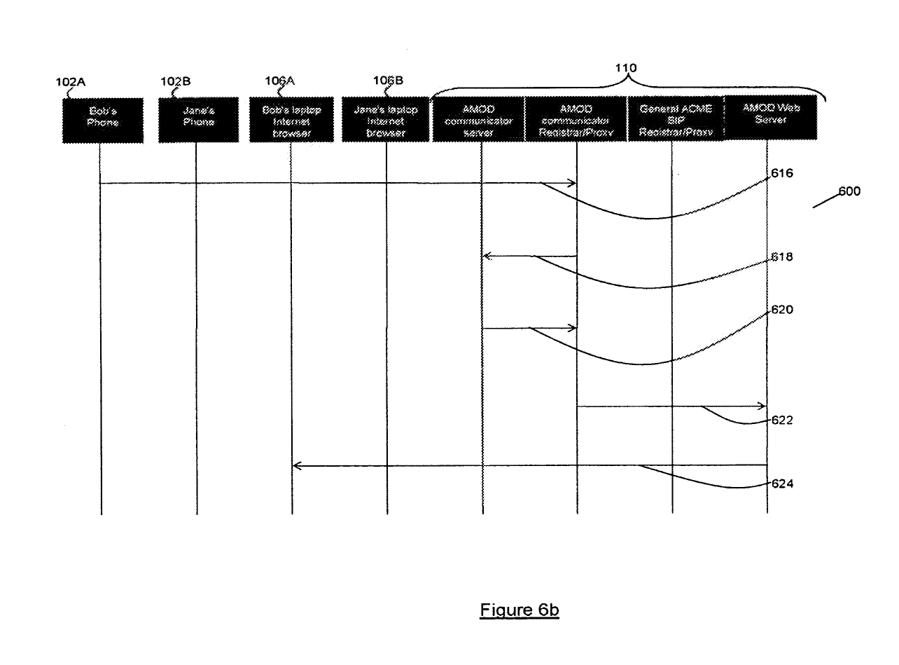

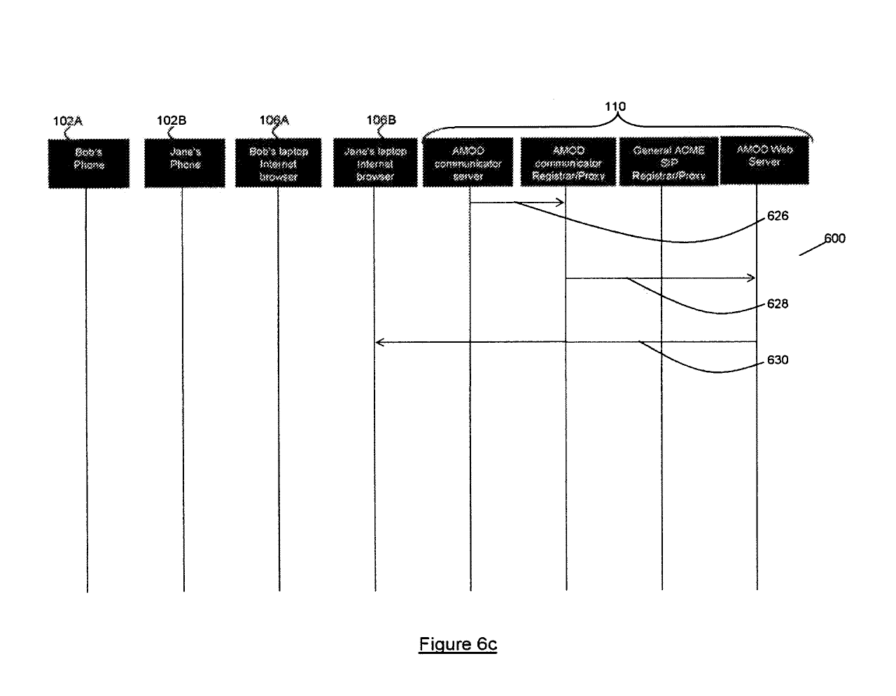

FIGS. 6a to 6c are messaging sequencing charts showing the establishment of a data communications channel in accordance with a further embodiment of the present invention.

Referring to FIG. 1, there is provided a communications system indicated generally by the reference numeral 100. The communications system 100 comprises a pair of mobile communications devices 102A, 102B and a pair of user devices 106A, 106B.

An originating mobile communications device 102A establishes a voice communications channel 104 with a destination mobile communications device 102B. At the same time that the voice communications channel 104 is established between the originating mobile communications device 102A and the destination mobile communications device 102B, the originating mobile communications device 102A transmits a data communications channel request message to a communications management hub 110 over a data communications link 108.

In a preferred embodiment, it is envisaged that the Session Initiation Protocol (SIP) will be used to control and manage the establishment of a data communications channel 107 and that the data communications channel message is a SIP message. It will be appreciated that other SIP messages as are well known to be used in the establishment of data communications channels will also be used. Throughout the remainder of this specification, the embodiments hereinafter described will be done so with reference to the SIP, however, it will be readily understood that various other messaging protocols, such as the Intelligent Network Application Part (INAP) may be alternatively used.

The communications management hub 110 comprises a database (not shown) which can map any SIP message from the originating mobile communications device 102A to an associated originating user device 106A which is to form an end point of the data communications channel 107. Similarly, the SIP message from the originating mobile communication device 102A is mapped by the communications management hub 110 to an associated destination user device 106B which is also to form an end point of the data communication channel 107.

Standard SIP protocol messages are transmitted over various data communication links 108 between the originating mobile communication device 102A, the destination mobile communication device 102B, the originating user device 106A and the destination user device 106B in order to establish the data communications channel 107 between the originating user device 106A and the destination user device 106B.

The SIP messages which are sent over the various data communications links 108 are automatically generated within the mobile communications devices 102A, 102B in response to the user of the originating mobile communications device 102A making a voice call to the destination mobile communications device 102B.

In one embodiment which is viewed as particularly advantageous, an identification key associated with a mobile communication device 102A, 102B such as a Mobile Station Integrated Services Digital Network (MSISDN) number, a International Mobile Subscriber Identity (IMSI) number, a International Mobile Equipment Identity (IMEI) number or a Media Access Control (MAC) address may be used to form part of the SIP messages which are sent from the mobile communication devices 102A, 102B to the communications management hub 110. The SIP messages are thus automatically generated using one of these identification keys without any input from the user of the mobile communications devices 102A, 102B. Therefore, the establishment of a voice communication channel 104 between the originating mobile communications device 102A and the destination mobile communications device 102B results in an associated but separate data communications channel 107 being established between the originating user device 106A and the destination user device 106B.

In another embodiment, the identification key could be one of a user name, an e-mail address, an employee number, a Voice over Internet Protocol (VoIP) account name, or a fixed line telephone number.

The users of the mobile communications devices 102A, 102B may configure which user device 106A, 106B respectively is to be associated with their mobile communication device 102A, 102B. As discussed hereinbefore, the association between the mobile communications devices 102A, 102B and the user devices 106A, 106B is achieved through a mapping of automatically generated SIP messages by the communications management hub 110 to the appropriate user device 106A, 106B. This mapping is stored in the communications management hub 110 and the user may also configure a dynamic mapping which takes cognisance of the destination mobile communications device 102B, the time of day, the day of the week and other such information to allow different types of data communication channels 107 to be established dependent on, inter alia, at least one or more of the above-mentioned criteria.

It will be understood that the mobile communication devices 102A, 102B may alternatively be fixed line telephones capable of producing an identification key. For example, the communications system 100 shown in FIG. 1 would be useful for computer-related customer support agents working in a customer support centre. A consumer (not shown), calling from their mobile communications device 102A establishes a voice communication channel with a customer support agent (not shown) in the customer support centre on a telephone 102B in the customer support centre. As a result, a data communications channel 107 is automatically established between a computer 106B in the customer support centre and the consumer's computer 106A. The customer support agents may then remotely access the consumer's computer 106A in order to rectify any problems the consumer may be having with their computer 106A.

In an alternative example, work colleagues having mobile communication devices 102A, 102B establish the voice communications channel 104 between their respective communications devices in the normal manner over a cellular network. At the same time, a data communications channel 107 is established between their laptop computers 106A, 106B. The data communications channel 107 allows the colleagues to collaborate online in real time using their laptop computers 106A, 106B and a Web Server (not shown).

With reference to FIG. 2, wherein like parts previously described have been assigned the same reference numerals, a communications system indicated generally by reference numeral 200 comprises a pair of mobile communications devices 102A, 1026. As before, a voice communications channel 104 is established between the originating mobile communications device 102A and the destination mobile communication device 102B. A data communication channel 107 is established between the originating mobile communications device 102A and the destination mobile communication device 1028 as well.

In this embodiment, the communications management hub 110 receives a SIP message from the originating mobile communications device 102A over a data communication link 108. The communications management hub 110 maps the SIP message to the destination mobile communications device 102B. As a result, a data communications channel 107 is set up between the pair of mobile communication devices 102A, 102B. This data communications channel 107 may be used to send multimedia files such as picture files, audio files such as particular ring tones, video files, web links or web pages from the originating mobile communications device 102A to the destination mobile communication device 102B.

Consequently, a user of the originating mobile communications device 102A may specify that a particular picture, webpage, or ring tone is displayed or output from the destination mobile communication device 102B at the initiation of the voice communications channel 104 between the originating mobile communications device 102A and the destination mobile communications device 102B.

Referring to FIG. 3, wherein like parts previously described have been assigned the same reference numerals, there is provided a communications system indicated generally by reference numeral 300. The communications system 300 is designed to allow call conferencing to take place between a plurality of remotely located parties. A plurality of mobile communication devices 102A, 102B and 102C, used by the plurality of remotely located parties, phone in to the communications conference bridge 302 which also comprises the communications management hub. It will be readily understood that in further embodiments, the communications conference bridge 302 does not comprise the communications management hub, and both components are arranged separately from one another.

As each of the mobile communications devices 102A, 102B and 102C establishes a voice communications channel 104A, 1048 and 104C between themselves and the conference bridge 302 respectively, the communications management hub in the communications conference bridge 302 maps corresponding, automatically generated SIP messages from each of the mobile communications devices 102A, 102B and 102C to establish data communication channels 107 between the associated user devices 106A, 106B and 106C and the communications conference bridge 302.

As before, numerous data communication links 108 are used to send various SIP messages in order to establish the data communication channels 107. In this manner, the plurality of remotely located parties participating in the conference call can collaborate with one another using their user devices 106A, 106B and 106C over a shared online workspace. A Web Server (not shown) may be used to facilitate the online collaboration over the shared workspace.

Referring to FIG. 4, wherein like parts previously described have been assigned the same reference numerals, there is provided a communications system indicated generally by reference numeral 400. The communications system 400 comprises an originating mobile communications device 102A and a destination mobile communications device 102B. A user (not shown) attempts to establish a voice communications channel 104 between the originating mobile communications device 102A and the destination mobile communications device 102B. At the same time, the originating mobile communications device 102A generates a SIP request message. The communications management hub 110 maps the SIP message to a user database 402 of a VoIP service provider, wherein, it can be established whether or not the users of the mobile communication devices 102A and 102B have VoIP accounts. If the users of the mobile communication devices 102A and 102B have VoIP accounts, the voice communications channel 104 is terminated and replaced with a VoIP communications channel which is established over at least a pair of data communication channels 404A and 404B which connect the originating mobile communications device 102A and the destination mobile communications device 102B to the Internet 406 respectively. The communications management hub 110 may be used to store details regarding the VoIP account names associated with each of the users. Once the communications system 400 has established that both users have a VolP account with the same VolP service provider, their respective VoIP account names can be retrieved and used to establish the VoIP communication channel.

In another embodiment, it will be understood that the communications system 400 may check through a plurality of VoIP service providers to establish whether both of the users have accounts with one of the VoIP service providers.

In yet a further embodiment, it will be understood that the communications system 400 may check through alternative voice channel service providers to determine if a more economically efficient voice channel may be established between the users. For example, an internal company-wide telephone network may be used to provide the voice channel between the users or indeed any network which can provide a voice channel between the users may be used if that channel offers a cheaper alternative to the voice communications channel 104 which the originating mobile communications device 102A is attempting to establish between itself and the destination mobile communications device 102B.

In a further embodiment, it is envisaged that users will be able to disable such a feature if so desired.

With reference to FIGS. 5a to 5c inclusive, there is provided a messaging sequence chart indicated generally by reference numeral 500. The messaging sequence chart 500 illustrates the flow of messages between the originating mobile communications device 102A, referred to as ‘Bob's Phone’ in FIGS. 5a to 5c; the destination mobile communications device 102B, referred to as ‘Jane's Phone’ in FIGS. 5a to 5c; the originating user device 106A, referred to as ‘Bob's laptop SIP client’ in FIGS. 5a to 5c; and, the destination user device 106B, referred to as ‘Jane's laptop SIP client’ in FIGS. 5a to 5c, and, the communications management hub 110, which is separated into separate units as shown in FIGS. 5a to 5c. The separate units are referred to as the ‘AMOD communicator server’, the ‘AMOD communicator Registrar/Proxy’ and the ‘General ACME SIP Registrar/Proxy’.

A plurality of registration steps are carried out in the form of SIP registration messages which are initially sent in order to create the appropriate links between the originating mobile communications device 102A, the destination mobile communications device 102B, the originating user device 106A, and, the destination user device 106B within the units in the communications management hub 110.

In step 502, SIP registration message SIP:bobs_phone@x.x.x.x is registered as the contact for SIP:bobs_phone@acme.com with the General ACME SIP Registrar/Proxy. It should be noted that throughout the following description, the term ‘x.x.x.x’ represents an Internet Protocol (IP) address for a particular device. Thus, the IP address of Bob's phone 102A is registered with the General ACME SIP Registrar/Proxy, which is a SIP registrar of a company called ACME who employ Bob.

Jane is also employed by ACME and in step 504, SIP registration message SIP:janes_phone@x.x.x.x is registered as the contact for SIP:janes_phone@acme.com with the General ACME SIP Registrar/Proxy. Therefore, Jane's phone 102B is registered with the communications hub 110. In step 506, SIP registration message SIP:bobs_pc@x.x.x.x registers the originating user device 106A as contact for SIP:bobs_pc@acme.com with the General ACME SIP Registrar/Proxy, and, in step 508, SIP registration message SIP:janes_pc@x.x.x.x registers the destination user device 106B as contact for SIP:janes_pcp@acme.com with the General ACME SIP Registrar/Proxy.

In step 510, the SIP address SIP:bobs_PC@acme.com is registered with the AMOD communicator Registrar/Proxy as the contact address for the SIP address SIP:bob@amodcommunicator.acme.com. Moreover, in step 512, the SIP address SIP:bob@amodcommunicatoracme.com is registered with the AMOD communicator Registrar/Proxy as the contact address for the SIP address SIP:+447952020173@amodcommunicatoracme.com. In this manner, a message sent to SIP:+447952020173@amodcommunicator.acme.com will be re-routed to SIP:bob@amodcommunicator.acme.com, which in turn will be re-routed to SIP:bobs_PC@acme.com which is registered against the SIP address

SIP:bobs_pc@x.x.x.x, and thus, the communications system need only know that the phone number of Bob's phone is used as an identification key with his companies system to create the SIP message SIP:+447952020173@amodcommunicator.acme.com in order to route a message through to the device registered against Bob's mobile communications device, which is to say Bob's PC. As previously discussed, different identification keys may be used in the place of a phone number.

In an analogous manner, in step 514 SIP address SIP:janes_PC@acme.com is registered as a contact address for SIP:jane@amodcommunicatoracme.com, and in step 516, SIP address SIP:jane@amodcommunicatoracme.com is registered as contact for SIP:+447952020166@amodcommunicator.acme.com with the AMOD communicator Registrar/Proxy.

Lastly, during the registration process, in step 518, the SIP address SIP:amodcommunicatorserver@x.x.x.x is registered as a contact address for SIP:amodcommunicatorserver@amodcommunicator.acme.com

As a voice call is established between Bob's Phone (+447952020173) and Jane's Phone (+447952020166), a SIP message is generated by the SIP client in Bob's phone from SIP:+447952020173@x.x.x.x to SIP:amodcommunicatorserver@amodcommunicator.acme.com, and this SIP information message comprises the called number, +447952020166, and the calling number, +447952020173. This SIP message is sent in step 520 from Bob's phone 102A to the AMOD communicator Registrar/Proxy 110. The AMOD communicator Registrar/Proxy 110 knows that it needs to route the SIP message to the AMOD communicator server, as has been defined by the registration which occurred in step 518. Thus, a SIP message is sent to the AMOD communicator server, as shown in step 522, from SIP:+447952020173@x.x.x.x to SIP:amodcommunicatorserver x.x.x.x, with the SIP information message again comprising the called number +447952020166 and the calling number +447952020173.

The AMOD communicator server looks up its database and, in this embodiment, identifies that Bob's laptop SIP client, the originating user device 106A is associated with Bob's phone, the originating mobile communications device 102A, and Jane's laptop SIP client, the destination user device 106B is associated with Jane's phone, the destination mobile communications device 102B, and moreover, both Bob and Jane have specified that an online collaboration page be opened in their web browser on user devices 106A and 106B when a voice communications channel is opened between their mobile communication devices 102A, 102B. As hereinbefore described, it will be understood that factors such as time of day and/or day of the week may result in different types of data channels being established between the user devices 106A, 106B.

In step 524, the AMOD communicator server transmits a SIP refer message from SIP:amodcommunicatorserver@x.x.x.x to SIP:+447952020173@amodcommunicator.acme.com with a reference to a URL for an online collaboration web page. The AMOD communicator Registrar/Proxy receives this SIP message and forwards the message on to the General ACME SIP Registrar/Proxy in step 526 as a SIP refer message from SIP:amodcommunicatorserver@x.x.x.x to SIP:bobs_PC@acme.com with the reference to the URL for the online collaboration page. The AMOD communicator Registrar/Proxy forwards the SIP message on to the General ACME SIP Registrar/Proxy in step 526 because SIP:bobs_PC@acme.com has been registered against the SIP address SIP:+447952020173@amodcommunicator.acme.com so that all SIP messages that are sent to SIP:+447952020173@amodcommunicator.acme.com will be forwarded to SIP:bobs_PC@acme.com. In step 628, the General ACME SIP Registrar/Proxy sends a SIP refer message from SIP:amodcommunicatorserver@x.x.x.x to SIP:bobs_pc@x.x.x.x which again comprises the reference to the URL for the online collaboration page. The online collaboration web page can be then displayed by the web browser on the originating user device 106A, Bob's PC.

Similarly, mutatis mutandis, Jane's PC displays the online collaboration page as a series of SIP refer messages are sent from the AMOD communicator server to the destination user device 106B, Jane's laptop SIP client, in steps 530, 532 and 534. In step 530 a SIP refer message is sent from SIP:amodcommunicatorserver@x.x.x.x to SIP:+447952020166@amodcommunicator.acme.com with the reference to the URL for example the online collaboration page. In step 532, a SIP refer message is transmitted from SIP:amodcommunicatorserver@x.x.x.x to SIP:janes_PC@acme.com with the reference to the URL for the online collaboration page, and, in step 534 a SIP refer message is forwarded from SIP:amodcommunicatorserver@x.x.x.x to SIP:janes_pc@x.x.x.x with the reference to the URL for the online collaboration page. The online collaboration web page is then displayed by the web browser on Jane's PC. It will be readily understood that the SIP message may contain a reference to any type of URL, and not just an online collaboration page, and indeed may contain any type of message which could allow a data channel to be created between the users.

As can be seen, a telephone call between the originating mobile communications device 102A and the destination mobile communications device 102B results in an online collaboration web page being opened on the originating user device 106A and the destination user device 106B.

With reference to FIGS. 6a to 6c inclusive, there is provided a messaging sequence chart indicated generally by reference numeral 600. As before, the messaging sequence chart 600 illustrates the flow of messages between the originating mobile communications device 102A, referred to as ‘Bob's Phone’ in FIGS. 6a to 6c; the destination mobile communications device 102B, referred to as ‘Jane's Phone’ in FIGS. 6a to 6c; the originating user device 106A, referred to as ‘Bob's laptop Internet browser’ in FIGS. 6a to 6c; and, the destination user device 106B, referred to as ‘Jane's laptop Internet browser’ in FIGS. 6a to 6c, and, the communications management hub 110, which is split into separate units as shown in FIGS. 6a to 6c that are referred to as the ‘AMOD communicator server’, the ‘AMOD communicator Registrar/Proxy’, the ‘General ACME SIP Registrar/Proxy’ and the ‘AMOD Web Server’.

In this embodiment, the user devices 106A and 106B do not have SIP clients installed and consequently are unable to communicate SIP messages with other SIP-enabled devices. However, a technique to push messages via a HTTP client may be used instead of SIP messages to cause the user devices 106A, 106B to display the online collaboration web page.

As before, a plurality of registration steps must be carried out prior to using the communications systems for the first time.

In step 602, the originating mobile communications device 102A sends a SIP registration message to register the SIP address SIP:bobs_phone@x.x.x.x as a contact for SIP:bobs_phone@acme.com. In step 604, the destination mobile communications device 106B, Jane's Phone, sends a SIP registration message, SIP:janes_phone@x.x.x.x as contact for the SIP address SIP:janes_phone@acme.com.

As both user devices 106A, 106B do not have SIP clients, they do not register themselves with any of the units in the communications management hub 110. Instead, a Web Server is supplied by the communication system host and the SIP address formed by the identification key and the domain address, in this embodiment given by amodcommunicator.acme.com, is registered by the AMOD Web Server to be routed to the identification key at the IP address of the AMOD Web Server. Therefore, in step 606 a SIP registration message registers SIP:+447952020173@x.x.x.x as being the contact SIP address for any SIP messages that are transmitted to SIP:+447952020173@amodcommunicatoracme.com. It is the AMOD Web Server which implements the SIP client for the user devices 106A, 106B. The IP address used in step 606 above is the IP address of the AMOD Web Server itself. Similarly, in step 608, a SIP registration message registers SIP+447952020166@x.x.x.x as the contact for the SIP address SIP:+447952020166@amodcommunicatoracme.com. In effect, the AMOD Web Server acts as a ‘substitute’ SIP client for both Bob and Jane, and therefore the AMOD Web Server registers itself to receive any SIP messages that are sent to SIP:+447952020173@amodcommunicator.acme.com or SIP:+447952020166@amodcommunicatoracme.com.

As before, the AMOD communicator server registers itself with the AMOD communicator Registrar/Proxy. In step 610, a SIP Registration message to register the SIP address SIP:amodcommunicatorserver@x.x.x.x as being the contact address for any SIP messages sent to the SIP address SIP:amodcommunicatorserver@amodcommunicator.acme.com.

In step 612, a HyperText Transfer Protocol (HTTP) request is sent from Bob's Internet browser to the AMOD Web Server to request a page stored by the AMOD Web Server. In step 614, a HTTP request is also sent from Jane's Internet browser to the AMOD Web Server. It will be understood that by using this means, both Bob and Jane's laptops may open a particular page and receive information from the web page as the page is automatically updated and/or refreshed. When Bob and Jane's laptop send the above HTTP requests, a cookie will be sent from their respective laptops to identify their laptops. The AMOD Web Server may register the laptops using these cookies so that no login or access codes will be required. An identification code, which may preferably be the same as the identification key, will be used in the cookie to identify Bob and Jane. If Bob and Jane do not have the correct web page open to receive updates and refreshed web page, then the AMOD Web Server will store the information until Bob and/or Jane's laptop requests the appropriate web page to be displayed. Such identification and device registration processes using cookies are known from the technical field.

As a voice call is established between Bob's Phone (+447952020173) and Jane's Phone (+447952020166), a SIP message is generated by the SIP client in Bob's phone from SIP:bobs_phone@x.x.x.x to SIP:amodcommunicatorserver@amodcommunicator.acme.com, with a note comprising the called number, +447952020166, and the calling number, +447952020173. This SIP message is sent in step 616 from Bob's phone 102A to the AMOD communicator Registrar/Proxy 110. The AMOD communicator Registrar/Proxy 110 knows that it needs to route the SIP message to the AMOD communicator server, as has been defined by the registration which occurred in step 610. Thus, a SIP message is sent to the AMOD communicator server, as shown in step 618, from SIP:bobs_phone@x.x.x.x to SIP:amodcommunicatorserver@x.x.x.x, with the same SIP message comprising the called number +447952020166 and the calling number +447952020173.

As hereinbefore described in the preceding embodiment, the AMOD communicator server looks up its database and, identifies that the AMOD Web Server is associated with Bob's phone and Jane's phone. As before, both Bob and Jane have specified that an online collaboration page be opened in their web browsers should a voice communications channel be established.

The AMOD communicator server now needs to open the online collaboration web pages in the Internet browsers on Bob's laptop and Jane's laptop. A SIP refer message is sent from SIP:amodcommunicatorserver@x.x.x.x to SIP:+447952020173@amodcommunicator.acme.com in step 620. The SIP message comprises a reference to a URL for example the online collaboration web page. The AMOD communicator Registrar/Proxy routes this SIP message to the AMOD Web Server in step 622 using a SIP refer message from SIP:amodcommunicatorserver@x.x.x.x to SIP:+447952020173@x.x.x.x. In step 624, the AMOD Web Server transmits a HTTP response message to Bob's internet browser using a push HTTP message. It will be understood that in the absence of the availability of a HTTP push message, an alternative transmission means such as COMET, which is well known in the art and is used for pushing a message to a HTTP client, may be used. In this manner, the online collaboration web page will be opened in the web browser on Bob's laptop.

Analogously, in steps 626, 628 and 630 a SIP refer message is sent from the AMOD communicator server to the AMOD Web Server which then pushes a HTTP response message to the Internet browser of Jane's laptop. In step 626, a SIP refer message is sent from SIP:amodcommunicatorserver@x.x.x.x to SIP:+447952020166@amodcommunicator.acme.com. As before, the message comprises a reference to the URL for the online collaboration page. In step 628, a SIP refer message is transmitted from SIP:amodcommunicatorserver@x.x.x.x to SIP:+447952020166@x.x.x.x. And, in step 630, a HTTP response message is sent from the AMOD Web Server to Jane's Internet browser.

The online collaboration web page is thus displayed by the Internet browsers on both Bob's laptop and Jane's laptop.

It will be readily understood from the discussion hereinbefore, that any type of data channel may be established in place of a link from the laptops to an online collaboration web page.

In the event that a mobile communications device 102A, 102B, 102C is unable to establish a data communications link 108, a Short Messaging Service (SMS) maybe alternatively used to send a SMS message containing a SIP message from the mobile communication device 102A, 102B, 102C to an associated communications management server (not shown). The communications management server generates the appropriate SIP message from this initial SMS message and transmits the SIP message onward to the communications management hub 110 where it is dealt with in the normal manner. Thus, the present invention will work seamlessly in areas having low data bit rates, such as are occasionally found on 2G networks. It will be readily understood that in the case that different protocols are used to communicate messages between the user devices and the communications management hub 110, the appropriate message for that protocol will be sent by SMS message.

In a further embodiment, user A decides to share a file with User B. The users are not within range of file transfer options such as Bluetooth, or choose not to use Bluetooth. User A selects a file and uses whatever mechanism their communication device supplies to ‘right click’ on (i.e. select) the file. For example, User A's communication device may be a mobile phone and the user may select the file by using a menu or touching an icon that represents the file. Alternatively, User A may start a communicator phone application and use it to choose a file to transfer. User A may then choose to send the file to User B by, for example, selecting ‘Send to other user via communicator’ from a menu on its communication device.

The communicator phone application may then take control of the file transfer and ask User A to enter a unique identifier for User B, such as User B's phone number. In the alternative, User A may enter User B's name and User B's number will be taken from their communication device's contacts information (if the name has multiple phone numbers in the contacts, User A may be prompted to choose one or more phone numbers). After entering the number or name of User B, User A initiates the file transfer by, for example, selecting “send” on its communication device.

The file is sent to a web server file transfer URL address with parameters including User A's and User B's unique identifiers. For example, part of the URL may include both phone numbers. In one embodiment, User B may be made aware that they have a file to receive. For example, User B may be made aware through a separate discussion with User A or via a message such as an SMS, Email, Tweet, or instant message generated by the communicator web server or a third party program. User B may start the communicator phone application on their phone, or it may start automatically, and may choose to receive the file by, for example, selecting a “receive file” option. User B enters a unique identifier for User A, such as User A's phone number, and a message is sent to the web server receive file URL address with parameters including User A's and User B's unique identifiers. For example, part of the URL may include both phone numbers. In one embodiment, when the application is started on User B's phone it will automatically check for files from all of User B's known contacts and inform User B of any available tiles. The web server downloads the file to User B's phone via a communication network. The communicator phone application enables storage of the file in any available location, such as on the phone internal or external memory.

The embodiments described herein also include security features that check the identity of each user. For example, in the embodiment described directly above, when a user sends a file to the web server, it includes in the message an identification token or certificate, using any of the commonly available secure authentication approaches or a proprietary approach, which confirms to the server that the message and the attached file really is from this user. The authentication approach may have been set up when the user first registered for the application or when they user first downloaded and started the application on their communication device. Similarly, User B will send an identification token or certificate in the message to the web server when they are retrieving a file so the server knows they really are user B. In both cases, the registered authenticated identification for the user will be uniquely assigned to the unique identifier of that user, such as the phone number. In this way, another user cannot register and be assigned to another user's unique identifier.

It should be understood that any references to the terms ‘phone’ or ‘mobile communications device’ should be understood to include the hardware or software of a mobile telephone, a fixed line telephone or could also refer to an enhanced SIM card which is capable of storing and running at least of portion of the communications system hereinbefore described.

It should be noted that any relationship between parties who have a common SIP client may result in use of the above described embodiments.

It will be easily understood by those skilled in the art that any realisation of servers, databases and/or computer hardware referred to in the preceding specification may be achieved by separate pieces of physical hardware, by a single piece of physical hardware which is divided to serve a multitude of purposes or by virtual means as may be done using so-called cloud computing.

It will be readily appreciated by those skilled in the art that the ACME SIP Registrar/proxy is not an essential component of the above described embodiments. In a further embodiment, it is envisaged that the SIP messages can be routed to the appropriate address of the user's device using a third-party Registrar/proxy or the AMOD communicator Registrar/proxy

The terms “comprise” and “include”, and any variations thereof required for grammatical reasons, are to be considered as interchangeable and accorded the widest possible interpretation.

The invention is not limited to the embodiments hereinbefore described which may be varied in both construction and detail

1. A method wherein
the establishment of a telephony communications channel between communication devices over a telephony network is used to automatically establish a data communications channel between two or more user devices over a communications network, wherein
the data communications channel is associated with, but independent from, the telephony communications channel and;
the data communications channel is established using, in part, identification keys that are used to establish the telephony communications channel,

2. The method of claim 1 wherein a signaling protocol is used to establish the data communications channel, such as the Session Initiation Protocol (SIP), the Intelligent Network Application Protocol (INAP), Hyper Text Transfer Protocol (HTTP), or any COMET technique.

3. The method of claim 2, wherein an identification key, including one or more of a Mobile Station Integrated Services Digital Network (MSISDN) number, an International Mobile Subscriber Identity (IMSI) number, an International Mobile Equipment Identity (IMEI) number, a Media Access Control (MAC) address, an email address, a user name, a Voice over Internet Protocol (VOIP) account name, or a landline telephone number, is used to form, at least part of, an address, or unique identifier, of a party to the telephony or data communications channel.

4. The method of claim 2, wherein signaling protocol messages are automatically generated using an identification key without any input from the user of the communication device.

5. The method of claim 3, wherein the identification keys are mapped to a user device's address on the communications network using a mapping database stored in a communications management hub.

6. The method of claim 3, wherein the communications management hub includes a database which
maps a signaling protocol message from an originating communications device to an associated originating user device and;
maps a signaling protocol message from a destination communication device to an associated destination user device.

7. The method of claim 1, wherein the communication device and the user device are associated, at least in part, via an identification key.

8. The method of claim 3, wherein the identification keys are selectively mapped to the user device's address dependant, at least in part, upon user defined settings, stored in the communications management hub;
wherein said settings comprise one or more of: the day of the week, the time of day, the identification of the user establishing the telephony communications channel, privacy settings, the location of user devices, and/or the location of communication devices.

9. The method of claim 1, wherein the association between the telephony communication channel and the data communications channel is achieved through a mapping of automatically generated signaling protocol messages by a communications management hub to an appropriate user device.

10. The method of claim 1, wherein the communication devices are mobile communications devices, such as mobile telephones and the user devices are computers.

11-12. (canceled)

13. The method of claim 1, wherein the telephony network and the communications network are at least partially provided by the same network.

14. The method of claim 1, wherein a specific communication device is associated with a specific user device.

15. The method of claim 5, wherein the communications management hub is a communications conference bridge.

16. The method of claim 1, wherein the data communications channel is configured depending on user settings.

17. The method of claim 1, wherein the data communication channel is configured as an online collaboration over a shared workspace, a web link to a social networking site, or the like.

18. The method of claim 1, wherein a user does not need to define any addresses, ports, or other such configurations details for the data communication channel to be established.

19. (canceled)

20. The method wherein:
a voice call is established between a first user's communication device and a second user communication device;
a signaling protocol message is generated by the signaling protocol client in the first user's communication device wherein the message includes an identification key which includes the called number and an identification key which includes the calling number;
the message is sent from the first user's communication device to a communicator Registrar/Proxy;
the communicator Registrar/Proxy routes the message to a communicator server;
the communicator server looks up a database and identifies a user device that is associated with the first user's communication device and a user device that is associated with the second user's communication device;
the communicator server sends a second message to the communicator Registrar/Proxy enabling the establishment of a data communications channel between the indentified user devices;
the communicator Registrar/Proxy routes the second message to one or more of the indentified user devices so that the user devices can establish the data communications channel.

21. The method of claim 20, wherein the second message contains a reference to a URL for an online collaboration webpage.

22. A method wherein,
a first communications device sends a first signaling protocol registration message to register a unique identifier for a first user;
a second communications device sends a second signaling protocol registration message to register a unique identifier for a second user;
a web server acts as a substitute signaling protocol client for users devices associated with the first and second users that do not have such a client;
the web server registers the signaling protocol registration messages to be routed to the unique identifier at the IP address of the web server;
a communicator server registers itself with a communicator Registrar/Proxy;
a HyperText Transfer Protocol (HTTP) request is sent from a first user devices' internet browser to the web server to request a page stored by the web server wherein a cookie is sent from the first user device to identify the said user device;
a HTTP request is sent from a second user device's internet browser to the web server wherein a cookie is sent from the second user device to identify the said user device;

23. The method of claim 22, wherein
a voice call is established between the first communication device and the second communication device,
a signaling protocol message is generated by the signaling protocol client in the first communication device and sent to the communicator Registrar/Proxy wherein the message includes a unique identifier comprised, in part, of the called number and the calling number;
the communicator Registrar/Proxy routes the signaling protocol message to the communicator server;
the communicator server identifies, based upon a database, that the web server is associated with the first and second communication devices;
a signaling protocol message is sent from the communicator server to the communicator Registrar/Proxy, including a reference to a URL;
the communicator Registrar/Proxy routes this message to the web server;
the web server transmits a HTTP response message to the first user device's internet browser using a push HTTP message;
a signaling protocol refer message is sent from the communicator server to the web server which then pushes a HTTP response message to the Internet browser of the second user device wherein the message comprises a reference to the URL; and
whereby the communicator server opens an data communications channel on the internet browsers of the first user device and the second user device.

24. The method of claim 23, wherein the data communications channel is online collaboration web page.

25-26. (canceled)
